(19) United States
(12) Patent Application Publication
(10) Pub. No.: US 2010/0175965 A1
(43) Pub. Date: Jul. 15, 2010

(54) PALLET MONITORING SYSTEM AND MONITORING METHOD

(75) Inventor: Koji FUKUDA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/748,282

(22) Filed: Mar. 26, 2010

Related U.S. Application Data
(63) Continuation of application No. PCT/JP2007/068818, filed on Sep. 27, 2007.

(51) Int. Cl. B65G 49/00; B65G 47/00; G06F 19/00

(52) U.S. Cl. 198/339.1; 702/81

(57) ABSTRACT

According to one embodiment, a pallet monitoring system for monitoring pallets sequentially conveyed to stations provided along a conveyor path, the system includes: a monitor, connected to the stations. The monitor includes: a defect information collector configured to collect defect information on a defect occurring in the stations; an information storage module configured to store therein the defect information and identification information of the pallets; and a pallet identifier configured to identify the pallets causing a defective product based on the defect information and the identification information stored in the information storage module.

### CROSS-REFERENCE TO RELATED APPLICATIONS

This application is a continuation of PCT international application Ser. No. PCT/JP2007/068818 filed on Sep. 27, 2007 which designates the United States, incorporated herein by reference.

### BACKGROUND

1. Field

One embodiment of the present invention relates to a pallet monitoring system, and more specifically, to a pallet monitoring system and a monitoring method for monitoring pallets that convey products in a production process.

2. Description of the Related Art

In a product production line such as an assembly line, component parts of a product are usually conveyed on pallets and assembled thereon while being conveyed. FIG. 1 is an illustrative view of a production line where assembly tasks are performed on the pallets.

In FIG. 1, a conveyor path 2 that conveys a plurality of pallets 1 is, for example, a roller conveyor, and is configured to linearly convey the pallets 1 on rollers. The conveyor path 2 is a loop as illustrated in FIG. 1, and each of the pallets 1 is moved along the conveyor path. Stations ST-01 to ST-08 (eight stations in FIG. 1) are provided along the closed conveyor path 2. Each of the stations ST-01 to ST-08 comprises a device that performs an assembly process. Each of the pallets 1 is sequentially conveyed through the stations ST-01 to ST-08, while assembly is performed thereon.

The assembly process of a product begins when the pallet 1 reaches an assembly starting position S. The pallet 1 is conveyed to the station ST-01 along the conveyor path 2, and a component part of the product is mounted on the pallet 1 in the station ST-01. Then, the pallet 1 is conveyed to the station ST-02 along the conveyor path 2, and other component part is assembled with respect to the component part already mounted on the pallet 1. Then, the pallet 1 is further conveyed along a conveyor device 2, and the assembling is further performed sequentially through the stations ST-03 to ST-08. Finally, the assembling is completed at the station ST-08. Thereafter, the pallet 1 on which assembling is completed is conveyed to an assembly end position E where an assembled product is picked up. Then, the pallet 1 is conveyed along the conveyor path 2 to return to the assembly starting position S again, and an assembly process is restarted on the pallet 1.

For example, Japanese Patent Application Publication (KOKAI) No. S55-93300, Japanese Patent Application Publication (KOKAI) No. H8-215997, and Japanese Patent Application Publication (KOKAI) No. 2003-346212 proposes providing an identification number for each pallet to identify the pallets in a production line, thereby analyzing causes of defective products.

In the production line such as the assembly line, the defective product is produced for various reasons, such as due to defects of component parts or assembly tools, or due to defects in an assembly position detecting sensor or a component part positioning sensor. Furthermore, it is also concerned that the defective product is produced due to defective pallet. For example, conveyance and positioning accuracy of component parts mounted on the pallet cannot be assured when the pallet is broken, worn, deteriorated, or the like. Therefore, the product assembled using the defective pallet may cause the defective product.

When the defective pallet causing the defective product is cyclically used in the production line as illustrated in FIG. 1, the defect is generated for the assembly on the pallet every time the defective pallet is used in each station, ending up with many defects. When only a small number of pallets are circulated on the conveyor, a manager of the production line may be able to recognize the defective pallet because the same failure has been occurring to the same pallet, thereby able to deal with the failure. However, when a large number of pallets are circulated, it is difficult to specify a particular pallet causing the defective product.

Japanese Patent Application Publication (KOKAI) No. S55-93300, Japanese Patent Application Publication (KOKAI) No. H8-215997, and Japanese Patent Application Publication (KOKAI) No. 2003-346212 disclose technologies managing pallets by providing identification numbers thereto, to manage the occurrence of defects. However, no reference is made about pallets as the cause of defects; therefore, defects that are caused by pallets cannot be prevented.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a production line where assembly tasks are performed on pallets;

FIG. 2 is an exemplary schematic diagram of an assembly line to which a pallet monitoring system is incorporated, according to an embodiment of the invention;

FIG. 3 is an exemplary block diagram of a monitoring device illustrated in FIG. 2, in the embodiment;

FIG. 4 is an exemplary table of contents of information collected by the monitoring device from stations in the embodiment;

FIG. 5 is an exemplary table of contents of information including error details and problems of pallets in association with each other, in the embodiment;

FIG. 6 is an exemplary table of contents of information prepared by extracting error information of a specific pallet, in the embodiment;

FIG. 7 is an exemplary flowchart of exclusion process of a pallet in the embodiment;

FIG. 8 is an exemplary flowchart of repair process of a pallet in the embodiment; and

FIG. 9 is an exemplary table of repair history data in the embodiment.

### DETAILED DESCRIPTION

Various embodiments according to the invention will be described hereinafter with reference to the accompanying drawings. In general, according to one embodiment of the invention, a pallet monitoring system for monitoring pallets sequentially conveyed to stations provided along a conveyor path, the system comprises: a monitor, connected to the stations. The monitor comprises: a defect information collector configured to collect defect information on a defect occurring in the stations; an information storage module configured to store therein the defect information and identification information of the pallets; and a pallet identifier configured to identify the pallets causing a defective product based on the defect information and the identification information stored in the information storage module.

According to another embodiment of the invention, a monitoring method of pallets sequentially conveyed to stations provided along a conveyor path, the method comprises: reading identification marks of the pallets at the stations, and supplying identification information of the pallets to a monitor; supplying defect information on a defect occurring in the stations to the monitor; storing the identification information of the pallets and the defect information in the monitor; and detecting a defect in the pallets based on the identification information and the defect information.

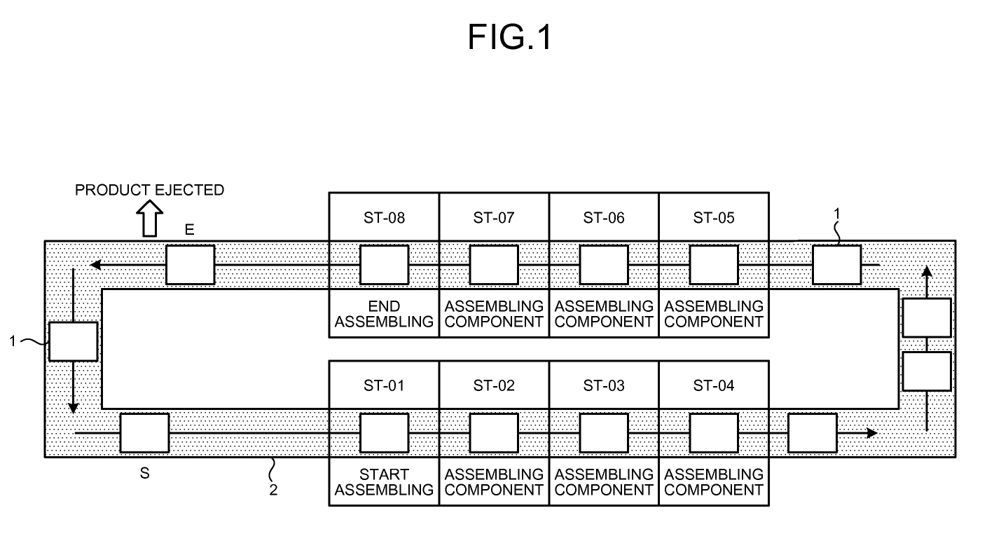

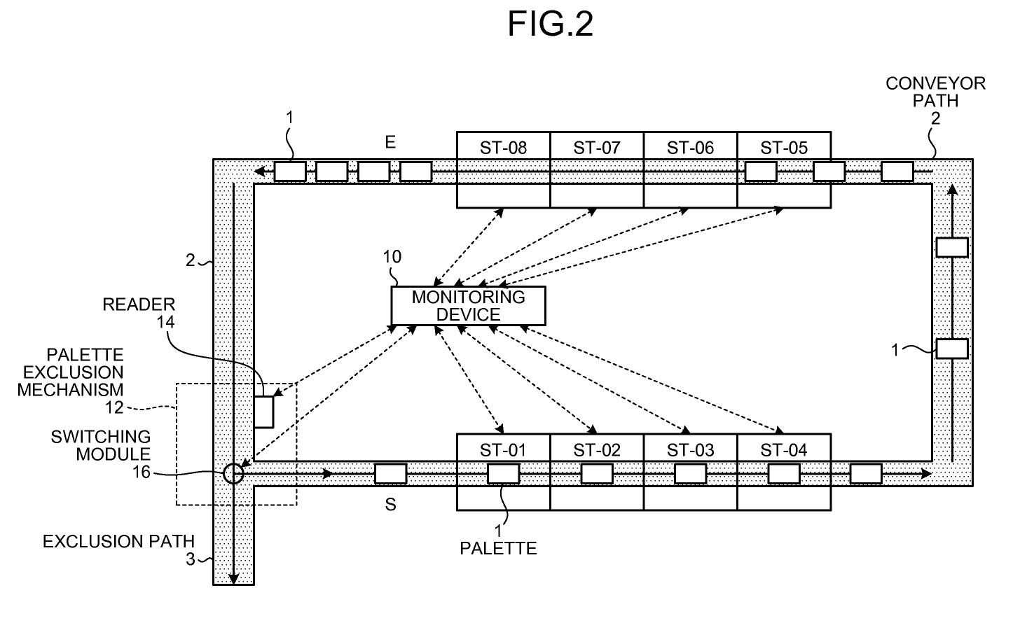

An embodiment according to the invention will be described hereinafter with reference to FIG. 2. FIG. 2 is a schematic overall diagram of an assembly line to which a pallet monitoring system according to the embodiment of the invention is incorporated. In FIG. 2, like numerals denote like elements in FIG. 1.

In FIG. 2, a conveyor path 2 that conveys a plurality of pallets 1 is, for example, a roller conveyor, and is configured to linearly convey the pallets 1 on rollers. The conveyor path 2 for the assembly line is a loop as illustrated in FIG. 2, and each of the pallets 1 is moved along the closed conveyor path 2. Stations ST-01 to ST-08 (eight stations illustrated in FIG. 1) are provided along the conveyor path 2. Each of the stations ST-01 to ST-08 comprises a device that performs an assembly process, e.g., mounting of component parts or tightening of screws. Each of the pallets 1 is sequentially conveyed through the stations ST-01 to ST-08, while assembling is performed with respect to the pallets 1.

The number of the pallets 1 is greater than the number of the stations provided along the conveyor path 2. In the example of FIG. 2, thirteen pallets 1 are provided on the conveyor path 2. Because the number of stations is eight, five pallets 1 are provided as spares on the conveyor path 2 and circulated along the conveyor path 2. Each of the pallets 1 is provided with a unique identification mark (or pallet number). Accordingly, the pallets can be identified by reading the respective identification marks.

An assembly process of a product begins when one of the pallets 1 reaches an assembly starting position S. The one of the pallets 1 (first pallet 1) is conveyed to the station ST-01 along the conveyor path 2, and a component of the product is mounted on the first pallet 1 in the station ST-01. Meanwhile, another one of the pallets 1 (second pallet 1) is conveyed to the assembly starting position S. Thereafter, the first pallet 1 in the station ST-01 is conveyed to the station ST-02 along the conveyor path 2, where other component is assembled with respect to the component already assembled on the first pallet 1. Meanwhile, the second pallet 1 is conveyed from the starting position S to the station ST-01 along the conveyor device 2.

In this manner, each of the pallets 1 is conveyed along the conveyor device 2 so that the assembling is performed sequentially through the stations ST-01 to ST-08, and the assembling is completed at the station ST-08. Each of the pallets 1 on which the assembling is completed is conveyed to the assembly end position E where assembled product is ejected from the pallet 1. Then, the each of the pallets 1 from which the assembled product is ejected is conveyed along the conveyor path 2 to return to the assembly starting position S again, and an assembly process is restarted on the each of the pallets 1.

According to the present embodiment, the assembly line described above comprises a monitoring device 10 and a pallet exclusion mechanism 12 to provide a pallet monitoring system.

The monitoring device 10 may comprise, but not limited to, a personal computer. In other words, the monitoring device 10 maybe any device that has arithmetic function, information storage function, and communication function. Alternatively, such functions of a monitoring device 10 maybe incorporated in an existing sequencer that manages and controls process. The monitoring device 10 is coupled to each of the stations ST-01 to ST-08, thereby enabling communications of information with respect thereto.

Each of the stations ST-01 to ST-08 has, besides the device that performs the assembly process, a device configured to detect the positions of each of the pallets 1, a device configured to identify the identification marks (pallet numbers) of the pallets 1, and a device configured to detect failures in the respective stations. These devices are coupled to controllers for controlling the whole of the respective stations ST-01 to ST-08. The monitoring device 10 communicates with the controllers of the stations ST-01 to ST-08, thereby collecting information on failures (errors) occurring in the stations ST-01 to ST-08.

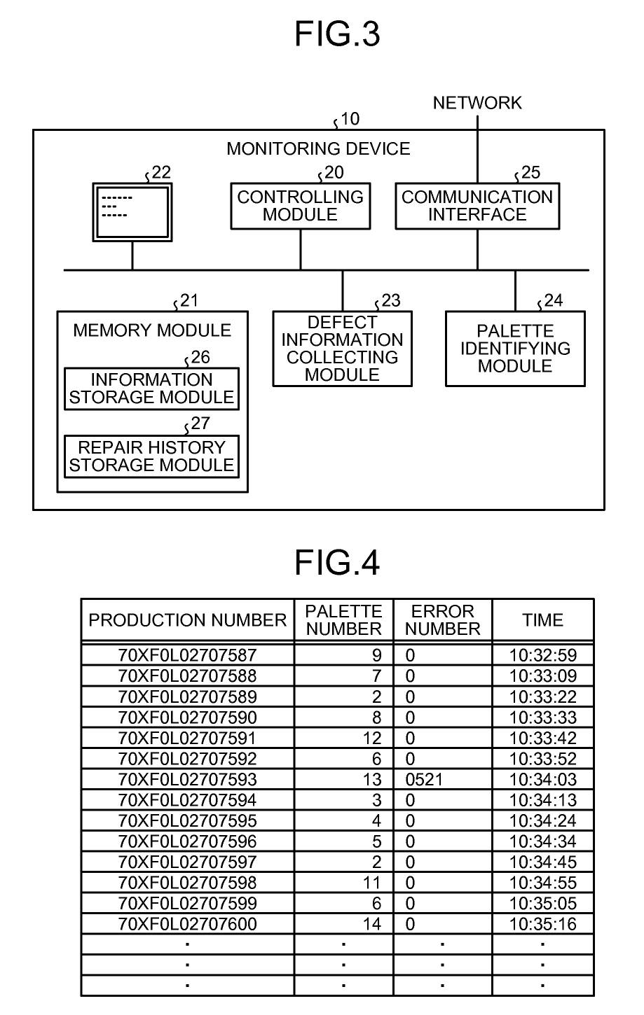

FIG. 3 is a block diagram of the whole configuration of the monitoring device 10. The monitoring device 10 comprises a controlling module 20 that is a microcomputer, for example; a memory module 21 that is a memory or a storage device, for example; and a displaying module 22 that is a display configured to display information stored in the memory module 21. The monitoring device 10 also comprises a defect information collecting module 23 configured to collect information on failures (errors) occurring in the stations ST-01 to ST-08 as described later, and a pallet identifying module 24 configured to identify a pallet with a defect based on the collected failure information. The monitoring device 10 also comprises a communication interface 25 to communicate information with external apparatuses or networks. The defect information collecting module 23 can collect information over a network comprising the stations ST-01 to ST-08, for example, via the communication interface 25.

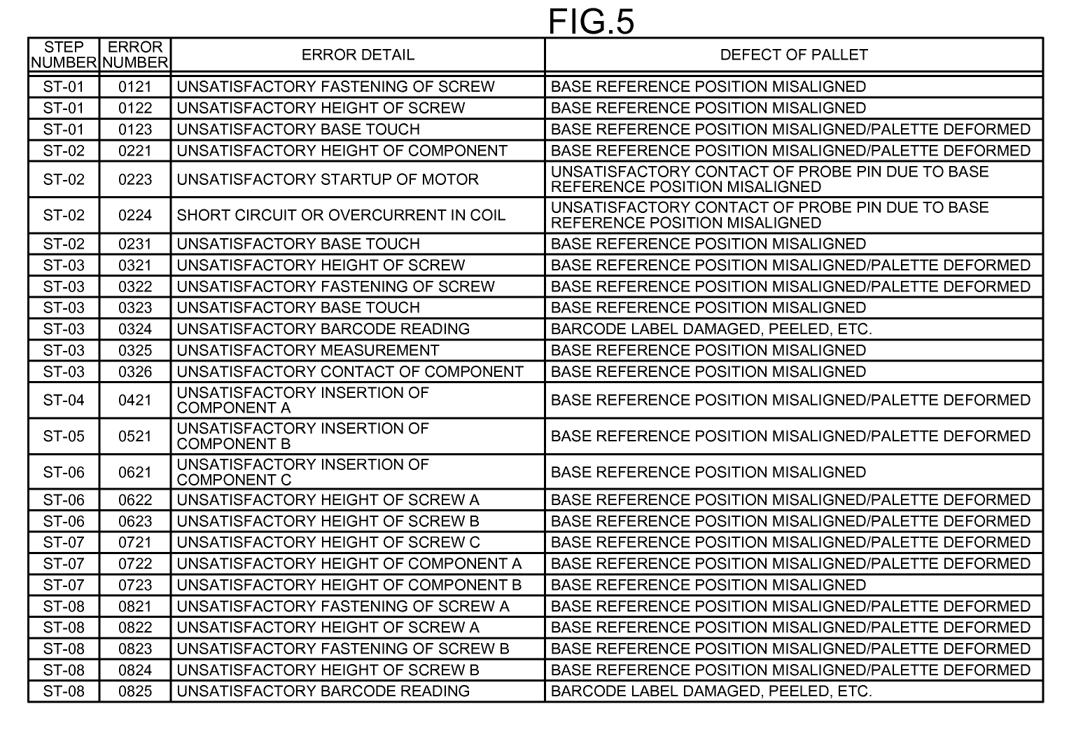

FIG. 4 is a schematic of contents of information collected by the monitoring device 10 from the stations ST-01 to ST-08. The stations ST-01 to ST-08 send information to the monitoring device 10 every time a failure determination is made in the stations ST-01 to ST-08. The information comprises, as listed in FIG. 3, the production number of the product, the pallet number of the pallet on which the product is placed, a determination result for defect (error number), and time at which the failure determination was made.

For example, the first item row in FIG. 4 represents that the product of product number 70XF0L0270259 placed on the pallet of pallet number 14 causes a determination result of error number 0521 at 10:34:02″. Error number 0 represents the product is determined not to be defective, and any other numbers represent the product is determined to be defective. The seventh item row in FIG. 4 represents that the product of product number 70XF0L0270258 placed on the pallet of pallet number 9 causes a determination result of error number 0521 at 10:32:59″. Accordingly, error details can be understood based on these error numbers described later.

An information storage module 26 in the memory module 21 of the monitoring device 10 stores therein information as listed in FIG. 5. Accordingly, with reference to the error numbers described above, it becomes apparent as to what kind of failure is occurred. In the first item row in FIG. 5, the error number 121 indicates unsatisfactory tightening of screw as a result of the process at the station ST-01. Additionally, if the unsatisfactory tightening of screw is caused due to the pallet, the first item row further indicates the defect of the pallet that causes the unsatisfactory tightening of screw. In other words, the information storage 26 stores therein error details and failures in pallets in association with each other.

FIG. 5 represents exemplary error information involved in an assembly line of a hard disk apparatus. For example, among the error details listed in FIG. 5, “unsatisfactory startup of motor” indicates that a spindle motor for disk rotation has failed to start. Further, “short circuit or overcurrent in coil” indicates that the coil of the spindle motor has been short-circuited or an overcurrent has flown in the coil. Still further, “unsatisfactory base touch” indicates that the pallet has failed to stop at a predetermined position. Still further, “unsatisfactory barcode reading” indicates that the barcode attached to the pallet as the identification mark of the pallet has failed to be read.

The column listing the defects of conveyed pallets in FIG. 5 indicates the defects of the pallets corresponding to respective error details. For example, if the “unsatisfactory tightening of screw” represented by the error number 0121 is caused due to the pallets, the defects of the pallets causing the unsatisfactory tightening is indicated in the item under “defect of pallet”. For example, the unsatisfactory tightening of screw may be caused due to a misalignment of a stop position of the pallet, because the misalignment causes a misalignment of screw hole, thereby the screw is caused to be tilted. Therefore, the failure of the conveyed pallet in FIG. 5 indicates “base reference position misaligned”. In other words, the error occurs because the position of the base reference mark for specifying the position of the pallet is misaligned, and the pallet has failed to stop at the position at which it is supposed to stop. For another example, if the “unsatisfactory barcode reading” represented by error number 0324 is caused due to the defects of the pallets such as damage or peeling of a barcode label on the pallets, whereby the barcode has failed to be read.

As described above, the information storage 26 in the memory module 21 of the monitoring device 10 stores therein errors occurring in the stations ST-01 to ST-08, and stores also defects of the pallets if the error is caused by the defects of the pallets.

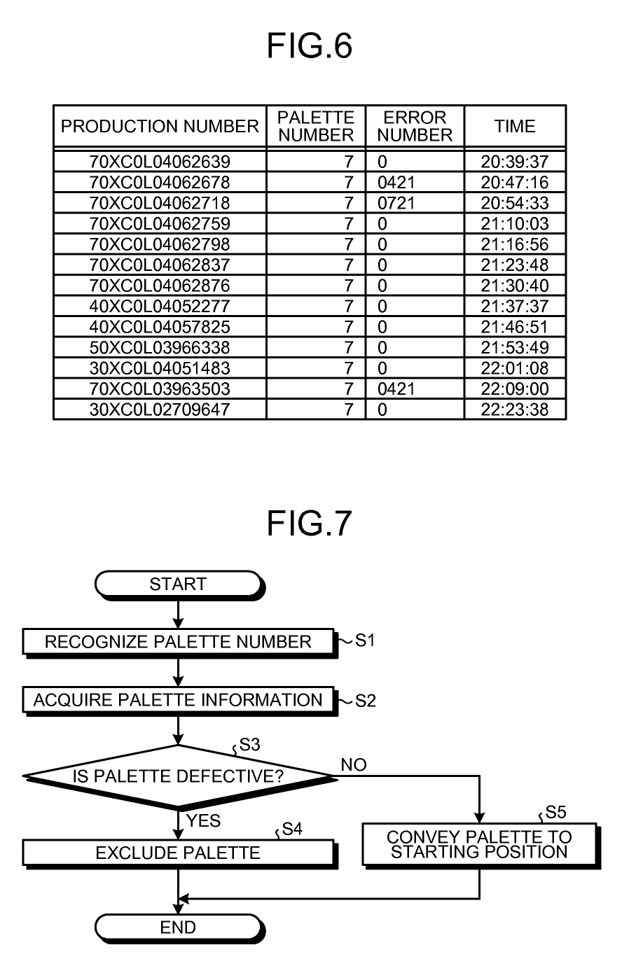

The monitoring device 10 can extract pieces of information listed in FIG. 4 for each pallet number, and can display the pieces on the displaying module 22. FIG. 6 represents extracted error information only of pallet number 7. Accordingly, the manager of the production line can refer to the displayed list and readily recognize what kinds of defects the pallets have.

Referring back to FIG. 2, the pallet exclusion mechanism 12 comprises a reader 14 that reads identification marks (pallet numbers) of the pallets, and a switching module 16 that changes a direction to which the pallets 1 on the conveyor path 2 are conveyed.

The reader 14 recognizes the pallet numbers of the respective pallets 1 by image recognition, for example, and notifies the monitoring device 10 of the number of the pallet 1 currently over the reader 14.

The pallet exclusion mechanism 12 changes a direction to which the pallets 1 are conveyed based on commands from the monitoring device 10. The direction to which the pallets 1 are conveyed is either a normal direction to which the pallets 1 is conveyed to the assembly starting position S or another direction to which the pallets 1 follows an exclusion path 3 branched from the closed loop of the conveyor path 2. In other words, the monitoring device 10 operates the pallet exclusion mechanism 12 to exclude the pallets 1 determined to have a defect by the pallet identifying module, from the conveyor path 2.

FIG. 7 is a flowchart of exclusion process for a pallet. The process starts with S1 where the reader 12 reads the identification mark of the pallet 1 that has been conveyed, and acquires its pallet number. The pallet number of the pallet 1 that has been conveyed is then sent to the monitoring device 10. At S2, the pallet identifying module 24 of the monitoring device 10 determines whether the pallet has any defect, based on error information associated with the pallet number sent from the reader 12. For example, the pallet identifying module 24 extracts error information only of the pallet number listed in FIG. 6, and determines whether the pallet 1 of FIG. 6 has the same defect. Among ten errors occurred in a single pallet 1 in the past, if five errors are caused by the same defect, the error detail of the five errors is determined as being caused by the pallet. In other words, at S3, the pallet identifying module 24 of the monitoring device 10 determines whether the pallet 1 having the pallet number sent from the reader 12 has a defect, so as to identify a defective pallet. The criteria for determination can be changed as required with new criteria input into the monitoring device 10.

If the pallet 1 having the pallet number sent from the reader 12 is the defective pallet, the process proceeds to S4. At S4, the monitoring device 10 sends a command to the switching module 16 in the pallet exclusion mechanism 12 to change directions in which the pallet 1 in question is conveyed to follow the exclusion path 3. By contrast, if the pallet 1 having the pallet number sent from the reader 12 is not the defective pallet, the process proceeds to S5. At S5, the monitoring device 10 sends a command to the switching module 16 in the pallet exclusion mechanism 12 to operate the switching module 16 so that the pallet 1 is directed to the assembly starting position S on the conveyor path 2. Normally, the pallet 1 is directed to the assembly starting position S, and only when the pallet 1 is determined to be defective, the pallet 1 is conveyed to follow the exclusion path 3 to be excluded from the closed loop of the conveyor path 2.

Accordingly, with the pallet monitoring system according to the present embodiment, whether the pallets 1 are defective is determined automatically, and only the pallets 1 that are determined to be defective based on the determination results are excluded from the conveyor path 2. Consequently, defective pallets are not used continuously, thereby a low product defective rate and high yield are achieved.

The pallets 1 on the exclusion path 3 are subjected to repairs. Here, a repair person readily recognizes what kinds of defects the pallets 1 have based on the error information accumulated in the monitoring device 10. For example, by displaying on the displaying module 22 of the monitoring device 10 the error information associated with the pallet numbers of the pallets that have been excluded, the repair person can recognize the error numbers. Accordingly, when the repair person operates the system to display the information listed in FIG. 5 on the displaying module 22 of the monitoring device 10, the repair person readily recognizes the defects of the pallets corresponding to the error numbers. In this manner, the repair person can readily determine where to check and repair in the pallets.

The repair person can also input information on repair details as repair history information in the monitoring device 10. The repair history information is accumulated in a repair history storage module 27 in the memory module 21. In this manner, the repair person can operate the system to display the repair history information on the displaying module 22 as well, and can repair the identified defective pallets while referring to the past repair history.

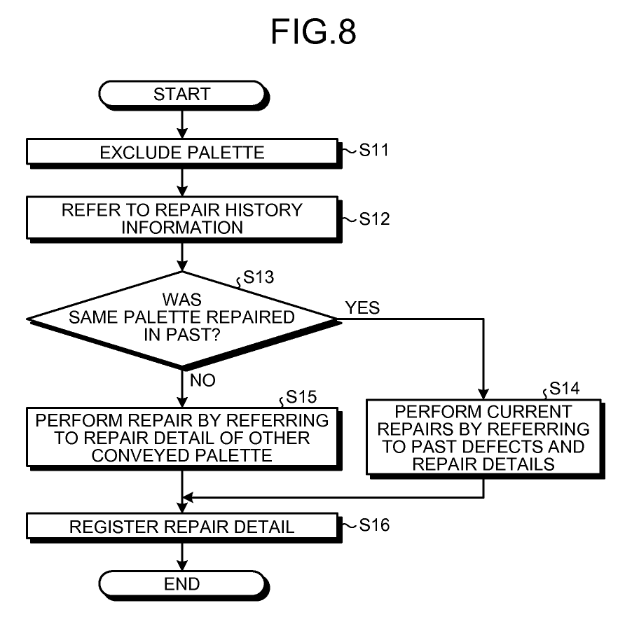

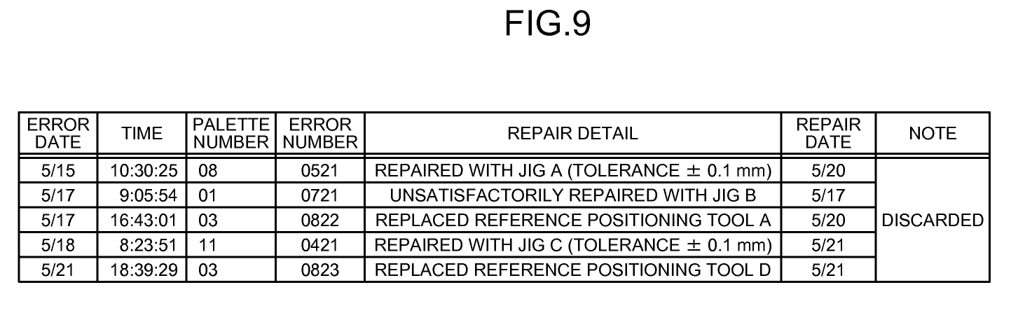

FIG. 8 is a flowchart of the repair process for repairing a pallet with failure, while referring to information. If one pallet 1 is excluded as being defective at S11, the repair person operates the system to display the repair history information on the displaying module 22 of the monitoring device 10 (S12). At S13, the repair person checks whether the pallet was repaired in the past, by referring to the repair history information. If the pallet has been repaired in the past, the process proceeds to S14, and the pallet is repaired based on the past repair details. On the other hand, if the same pallet has not been repaired in the past, the process proceeds to S15, and the pallet is repaired by referring to repair details of other pallets. Subsequently, the current repair details are input in the monitoring device 10 (S16), and the process is completed. The repair information input to the monitoring device 10 is accumulated in the repair history storage module 27 in the memory module 21, and can be displayed on the displaying module 22 as required as illustrated in FIG. 9. The repair information accumulated in the repair history storage module 27 preferably comprises, as illustrated in FIG. 9, the date and time of when an error of the pallet occurred, the pallet number of the pallet with which the error occurred, the error number of the error that occurred, repair details of the pallet, the repair date, and other notes. The contents of the information accumulated as repair information may be changed as appropriate.

Accordingly, with the pallet monitoring system according to the present embodiment, the states of past repairs of a pallet can readily recognized, and the repairing of the pallet can be performed efficiently.

While the monitoring device 10 is a single personal computer in the embodiment, it is not limited thereto; a plurality of computers, a memory apparatus, a display apparatus, and the like connected over a network may provide the functions of the monitoring device 10.

According to the embodiment, a pallet having a defect causing a defective product can be specified, so that the only defective pallet can be removed from the production line. Therefore, the occurrence of defect due to the defective pallet can be promptly recognized, thereby improving the yield ratio of the product.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A pallet monitoring system for monitoring pallets conveyed to stations along a conveyor path, the system comprising:
a monitor connected to the stations, comprising:
a defect information collector configured to collect defect information on a defect in the stations;
an information storage module configured to store the defect information and identification information of the pallets; and
a pallet identifier configured to identify the pallets associated with a defective product based on the defect information and the identification information in the information storage module.

2. The pallet monitoring system of claim 1, wherein the monitor further comprises a display configured to display information on the pallets associated with the defective product.

3. The pallet monitoring system of claim 1, further comprising
a reader in the conveyor at an upper stream side of one of the stations configured to execute first process, and configured to read identifiers of the pallets, wherein
the reader is connected to the monitor.

4. The pallet monitoring system of claim 3, further comprising:
a pallet remover configured to remove the pallets associated with the defective product from the conveyor path, wherein
the monitor is configured to control the pallet remover based on information read by the reader.

5. The pallet monitoring system of claim 2, wherein
the monitor further comprises a repair history storage module configured to store repair history information of the pallets, and
the repair history information is displayed on the display.

6. A monitoring method of pallets conveyed to stations along a conveyor path, the method comprising:
reading identifiers of the pallets at the stations, and supplying identification information of the pallets to a monitor;
supplying defect information on a defect in the stations to the monitor;
storing the identification information of the pallets and the defect information in the monitor; and
detecting a defect in the pallets based on the identification information and the defect information.

7. The monitoring method of claim 6, further comprising:
displaying the identification information and the defect information; and
displaying a result of the defect detection.

8. The monitoring method of claim 6, further comprising removing the pallets from the conveyor path, when the defect in the pallets is detected.

9. The monitoring method of claim 8, further comprising storing repair information, when the pallets removed from the conveyor path are repaired and reused.

10. The monitoring method of claim 8, further comprising displaying the repair information.
